(19) United States
(12) Patent Application Publication
(10) Pub. No.: US 2019/0094663 A1
(43) Pub. Date: Mar. 28, 2019

(54) Interlocking Camera Mount

(71) Applicant: John Jager, Plainwell, MI (US)

(72) Inventor: John Jager, Plainwell, MI (US)

(21) Appl. No.: 15/713,014

(22) Filed: Sep. 22, 2017

(51) Int. Cl. G03B 17/56

(52) U.S. Cl. CPC G03B 17/561; F16M 11/08

(57) ABSTRACT

An interlocking camera mount uses multiple interlocking links to form an articulated chain of camera mounts. To accomplish this, each interlocking link has a camera mount, and two pivotable bases. The camera mount is an attachment point to which a camera can be affixed. The pivotable bases are connection mechanisms that enable the interlocking links to be chained together and form an articulated chain. Additionally, the pivotable bases are positioned on opposite sides of the camera mount. Thus, facilitating the creation of a serially linked chain. Specifically, the pivotable bases of an arbitrary link are used to connect the arbitrary link to one or more adjacent links.

### FIELD OF THE INVENTION

The present invention relates generally to camera mounts. More particularly, the present invention relates to a camera mounting device that uses a plurality of interlocking links to create an articulated chain that is capable of maintaining multiple cameras in desired orientations.

### BACKGROUND OF THE INVENTION

There are multiple types of camera mounting mechanisms that photographers use to maintain a camera in a fixed position while taking pictures. These devices are designed to stabilize the camera beyond what would be possible if the photographer were to physical hold the camera. While these devices enable photographers to effectively capture long exposures, they frequently do not allow the photographer to capture a scene from multiple perspectives. To accomplish this feat, the photographer is forced to use multiple camera mounts. This requires the photographer to adjust the position of each camera mount, making simultaneously capturing multiple photos at the same height an arduous task.

The present invention, the interlocking camera mount, addresses these problems by providing a camera mount which can be strung together to form an articulated chain of camera mounts. That is, the present invention comprises a plurality of interlocking links that can be serially connected to create a chain of camera mounts. This enables the photographer to mount multiple cameras onto the present invention to create an array of cameras which are capable of capturing a scene from multiple perspectives.

### BRIEF DESCRIPTION OF THE DRAWINGS

FIG. 1 is a perspective view of the present invention.

FIG. 2 is a perspective view of a single interlocking link used in the present invention.

FIG. 3 is a top view of a single interlocking link used in the present invention.

FIG. 4 is a bottom view of a single interlocking link used in the present invention.

FIG. 5 is a left-side view of a single interlocking link used in the present invention.

FIG. 6 is an exploded perspective view of the present invention.

FIG. 7 is a left-side view of the present invention taken along line 7-7 in FIG. 3.

### DETAIL DESCRIPTIONS OF THE INVENTION

All illustrations of the drawings are for the purpose of describing selected versions of the present invention and are not intended to limit the scope of the present invention.

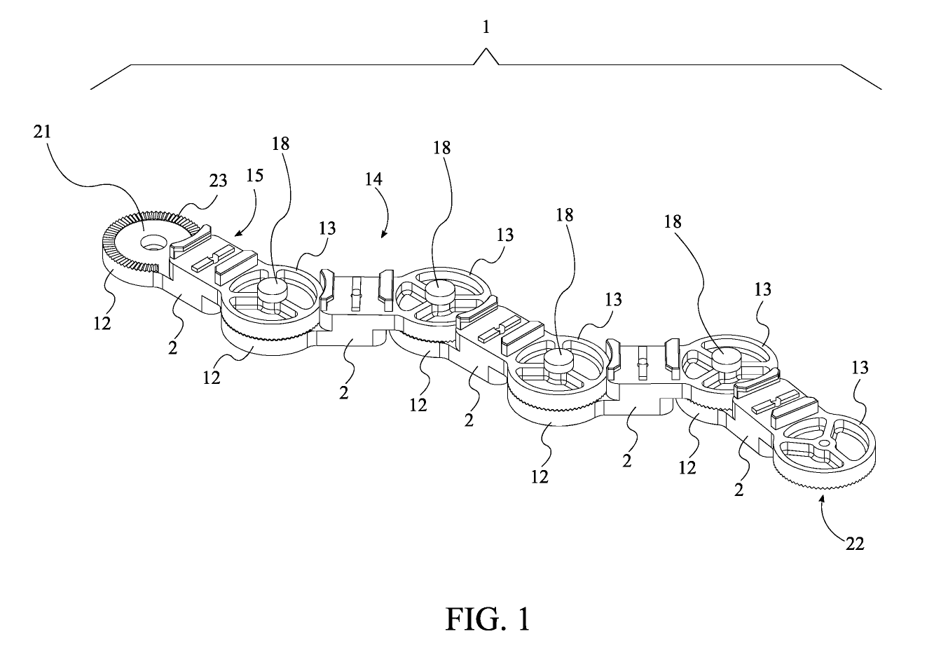

As can be seen in FIG. 1 through FIG. 7, the present invention, the interlocking camera mount, is a multipurpose camera-mounting device that is designed to create a reconfigurable chain of camera mounts. Each link in the chain of camera mounts functions as a mount for a single camera. Thus, a user of the present invention is able to capture a scene from multiple angles by attaching one or more cameras to the reconfigurable chain of camera mounts. Additionally, each link in the chain of camera mounts is designed to accommodate multiple types of camera-mounting mechanisms. Specifically, the present invention is designed to be an attachment point for cameras that are equipped with, but not limited to, universal threaded camera-mount connectors, clamping fasteners, and magnetic connectors.

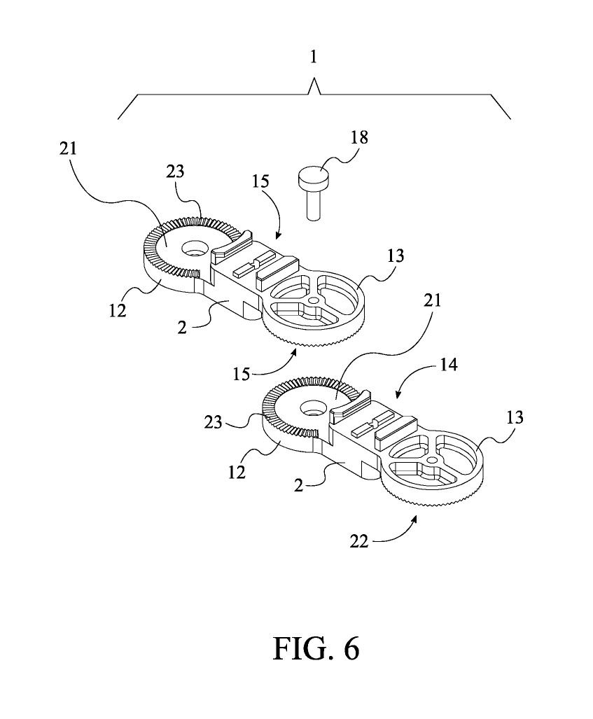

As can be seen in FIG. 1 and FIG. 6, to achieve the above-described functionality, the present invention makes use of a plurality of links to form an articulated chain. Specifically, the present invention comprises a plurality of interlocking links 1. Each of the plurality of interlocking links 1 comprises a camera mount 2, a first pivotable base 12, and a second pivotable base 13. The camera mount 2 is a rigid platform that functions as the connection point for attaching cameras to the present invention. The first pivotable base 12 and the second pivotable base 13 are platforms that are used to form pivoting attachments between the plurality of interlocking links 1. Specifically, the first pivotable base 12 is connected adjacent to the camera mount Likewise, the second pivotable base 13 is connected adjacent to the camera mount 2, opposite to the first pivotable base 12. As a result, the plurality of interlocking links 1 can be serially connected to form a chain of camera mounts. Additionally, the first pivotable base 12 and the second pivotable base 13 are positioned offset from each other along the camera mount. Consequently, the plurality of interlocking links 1 is able to form a chain of uniform thickness that can be rested onto surfaces without rocking or toppling over. The shape of the chain of camera mounts creates a surface on which cameras can be held steady. Because the attachment established between each of the plurality of interlocking links 1 is identical, only the attachment between two of the plurality of interlocking links 1 is described herein. That is, the arrangement of components is repeated for each attachment made in the chain of camera mounts. As such, the first pivotable base 12 of an arbitrary link 14 is rotatably attached to the second pivotable base 13 of an adjacent link 15, wherein the arbitrary link 14 and the adjacent link 15 are from the plurality of interlocking links 1. Thus attached, the arbitrary link 14 and the adjacent link 15 are able to be connected to subsequent links from the plurality of interlocking links 1. Specifically, the second pivotable base 13 of the arbitrary link 14 can be connected to the first pivotable base 12 of the subsequent link. In this instance, the subsequent link can be identified as the arbitrary link 14 and the interlocking link that was previously identified as the arbitrary link 14 is now identified as the adjacent link 15. As a result, the user is able to form chains of camera mounts that contain as many of the plurality of interlocking links 1 as are required.

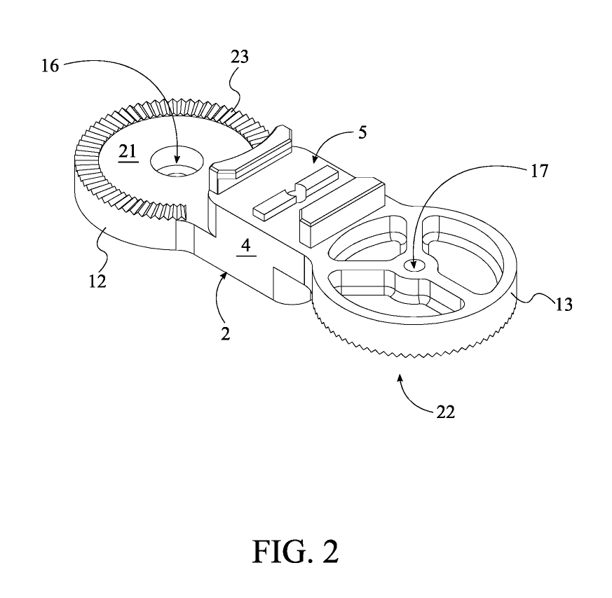

As can be seen in FIG. 2 and FIG. 6, the present invention is designed to enable the user to adjust the rotatable attachment formed between each of the plurality of interlocking links 1. To accomplish this, each of the plurality of interlocking links 1 further comprises a first fastening hole 16, a second fastening hole 17, and a fastener 18. The first fastening hole 16 and the second fastening hole 17 are holes that form a pivoting axis for the rotatable attachment between the arbitrary link 14 and the adjacent link 15. This is possible because the first fastening hole 16 traverses through the first pivotable base 12. Additionally, the first fastening hole 16 is centrally positioned on the first pivotable base 12. Similarly, the second fastening hole 17 traverses through the second pivotable base 13. Additionally, the second fastening hole 17 is centrally positioned on the second pivotable base 13. Thus positioned, the fastener 18 is able to pass through the first fastening hole 16 to form the rotatable attachment between the arbitrary link 14 and the adjacent link 15.

As can be seen in FIG. 2 and FIG. 6, the fastener 18 is preferably a rigid cylindrical connector. However, fasteners including, but not limited to, screws and nails can be used to establish the rotatable attachment between the first pivotable base 12 of the arbitrary link 14 and the second pivotable base 13 of the adjacent link 15. When the first pivotable base 12 of the arbitrary link 14 is attached to the second pivotable base 13 of the adjacent link 15, the first fastening hole 16 of the arbitrary link 14 and the second fastening hole 17 of the adjacent link 15 are concentrically aligned to each other. This creates a channel through the first pivotable base 12 of the arbitrary link 14 and the second pivotable base 13 of the adjacent link 15 that the fastener 18 is inserted into. As such, the fastener 18 is engaged through the first fastening hole 16 of the arbitrary link 14 and the second fastening hole 17 of the adjacent link 15. Accordingly, the first pivotable base 12 of the arbitrary link 14 and the second pivotable base 13 of the adjacent link 15 rotate about the fastener. Furthermore, the fastener 18 is preferably a screw that is used to lock the two components in place when engaged. That is, the user is able to prevent the first pivotable base 12 of the arbitrary link 14 and the second pivotable base 13 of the adjacent link 15 from rotating about the fastener 18 by tightening the fastener 18.

As can be seen in FIG. 1 through FIG. 7, each of the plurality of interlocking links 1 is equipped with a cylindrical connector and receptacle that sleeve the fastener 18 and facilitate establishing the rotatable attachment between the arbitrary link 14 and the adjacent link 15. Specifically, each of the plurality of interlocking links 1 further comprises a cylindrical protrusion 19 and a cylindrical receptacle 20. The cylindrical protrusion 19 is a hollow tube that extends from the second pivotable base 13. The first pivotable base 12 and the second pivotable base 13 are flat disks that are designed such that the second pivotable base 13 of the adjacent link 15 is placed on top of the first pivotable base 12 of the arbitrary link 14 when the two links are rotatably attached to each other. To facilitate this, an inner face 21 the first pivotable base 12 and an inner face 22 he second pivotable base 13 are oriented towards each other. The inner face 21 of the first pivotable base 12 is a flat surface that is positioned adjacent to the second pivotable base 13 when the second pivotable base 13 of the adjacent link 15 is rotatably attached to the first pivotable base 12 of the arbitrary link 14. Similarly, inner surface of the second pivotable base 13 is a flat surface that is positioned adjacent to the first pivotable base 12 when the second pivotable base 13 of the adjacent link 15 is rotatably attached to the first pivotable base 12 of the arbitrary link 14. As such, the inner face 21 of the first pivotable base 12 and the inner face 22 of the second pivotable base 13 are positioned parallel each other. Thus positioned, the inner face 21 of the first pivotable base 12 and the inner face 22 of the second pivotable base 13 facilitate forming a chain of camera mounts that creates a level surface on which to mount cameras. Further describing the rotatable attachment between the first pivotable base 12 of the arbitrary link 14 and the second pivotable base 13 of the adjacent link 15, the cylindrical receptacle 20 centrally traverses into the first pivotable base 12 from the inner surface of the first pivotable base 12. Additionally, the cylindrical protrusion 19 is centrally connected onto the inner surface of the second pivotable base 13. As a result, the cylindrical protrusion 19 is able to slide into the cylindrical receptacle 20 when the first pivotable base 12 of the arbitrary link 14 is rotatably attached to the second pivotable base 13 of the adjacent link 15.

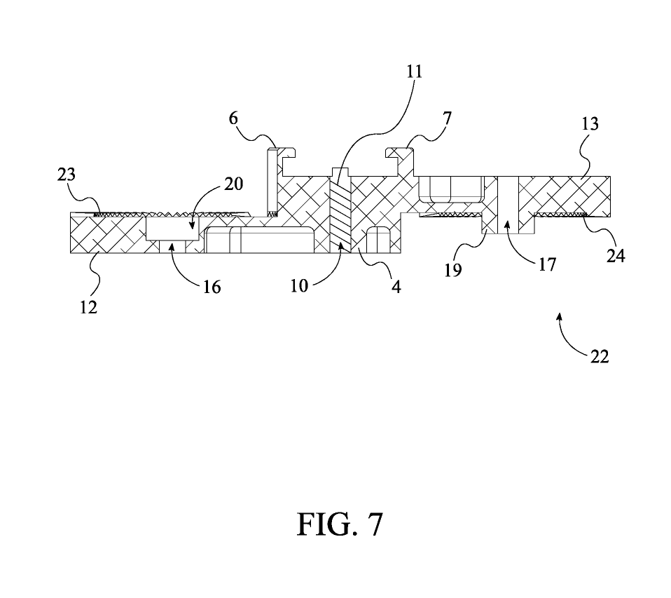

As can be seen in FIG. 6 and FIG. 7, the cylindrical protrusion 19 and the cylindrical receptacle 20 are positioned to facilitate establishing the pivoting attachment between the arbitrary link 14 and the adjacent link 15. As such, the cylindrical protrusion 19 of the adjacent link 15 and the cylindrical receptacle 20 of the arbitrary link 14 are concentrically aligned to each other. Furthermore, the cylindrical protrusion 19 of the adjacent link 15 and the cylindrical receptacle 20 of the arbitrary link 14 are engaged to each other. Accordingly, inserting the cylindrical protrusion 19 into the cylindrical receptacle 20 does not impede the pivoting motion of the arbitrary link 14 relative to the adjacent link 15. Additionally, the cylindrical receptacle 20 is concentrically aligned to the first fastening hole 16, such that the first fastening hole 16 traverses through the cylindrical receptacle 20 Likewise, the cylindrical protrusion 19 is concentrically aligned to the second fastening hole 17, such that the second fastening hole 17 traverses into the hollow cylindrical protrusion 19. This enables the fastener 18 to be engaged through the first fastening hole 16, the cylindrical protrusion 19, and the second fastening hole 17 when the first pivotable base 12 of the arbitrary link 14 is rotatably attached to the second pivotable base 13 of the adjacent link 15.

As can be seen in FIG. 1 and FIG. 7, the present invention enables the user to lock the first pivotable base 12 of the arbitrary link 14 and the second pivotable base 13 of the adjacent link 15 in place, such that the two components are unable to rotate while the lock is engaged. To accomplish this, each of the plurality of interlocking links 1 further comprises a first crown gear 23 and a second crown gear 24. The first crown gear 23 being integrated into the inner surface of the first pivotable base 12. Similarly, the second crown gear 24 being integrated into the inner surface of the second pivotable base 13. As a result, the user is able to lock the first pivotable base 12 of the arbitrary link 14 is and the second pivotable base 13 of the adjacent link 15 in a desired configuration by engaging the fastener 18 through the first fastening hole 16 and the second fastening hole 17. Thereby, forcing the teeth of the first crown gear 23 to engage the teeth of the second crown gear 24 and inhibiting the rotation of the first pivotable base 12 of the arbitrary link 14 relative to the second pivotable base 13 of the adjacent link 15. Specifically, the first crown gear 23 of the arbitrary link 14 and the second crown gear 24 of the adjacent link 15 are concentrically aligned to each other. Furthermore, the first crown gear 23 of the arbitrary link 14 and the second crown gear 24 of the adjacent link 15 are engaged to each other. Consequently, the first crown gear 23 of the arbitrary link 14 and the second crown gear 24 of the adjacent link 15 are positioned to be pressed against each other when the fastener 18 is engaged through the first fastening hole 16 of the arbitrary link 14 and the second fastening hole 17 of the adjacent link 15.

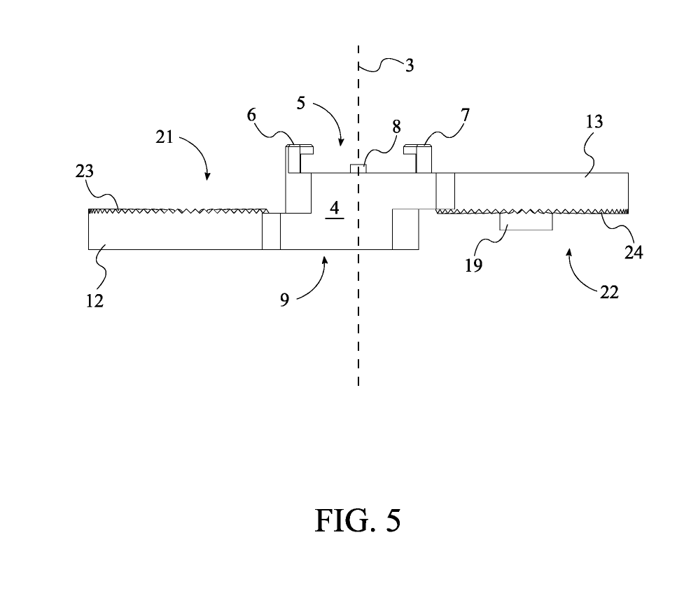

Regarding FIG. 5 and FIG. 6, as described above, the plurality of interlocking links 1 forms a chain of camera mounts that is of uniform thickness. Thus, creating a level surface for mounted cameras. The first pivotable base 12 and the second pivotable base 13 are positioned equidistant from a central axis of the camera mount 2 so that each of the plurality of interchangeable links is a symmetrical device which mitigates any unwanted rocking caused by an uneven distribution of weight. Additionally, the first pivotable base 12 is positioned offset from the second pivotable base 13 along a central axis 3 of the camera mount. Thus positioned, the first pivotable base 12 and the second pivotable base 13 facilitate forming a chain of camera mounts that has a uniform thickness.

As can be seen in FIG. 5 and FIG. 6, the present invention is designed to function as a mount for various types of cameras. To accomplish this, the camera mount 2 comprises a first attachment mechanism 5, a second attachment mechanism 9, and a mount body 4. The mount body 4 is the structural foundation for the camera mount 2 and acts as the component onto which the first attachment mechanism 5, the second attachment mechanism 9, the first pivotable base 12 and the second pivotable base 13 are connected. The first attachment mechanism 5 and the second attachment mechanism 9 are mounting devices that are designed to attach cameras to opposite sides of the camera mount. To accomplish this, the first attachment mechanism 5 is connected adjacent to the mount body 4 Likewise, the second attachment mechanism 9 is connected adjacent to the mount body 4, opposite to the first attachment mechanism 5. Thus positioned, the first attachment mechanism 5 and the second attachment mechanism 9 enable the user to use the present invention as a mounting device that connects to cameras which use disparate mounting systems. To do so, the user simply flips the camera mount 2 to reveal the first attachment mechanism 5 or the second attachment mechanism 9. Specifically, when the user is employing the first attachment mechanism 5 to attach a camera to the present invention, the second attachment mechanism 9 is positioned beneath the mount body 4. Conversely, when the user is employing the second attachment mechanism 9 to attach a camera to the present invention, the first attachment mechanism 5 is positioned beneath the mount body 4. Relatedly, the first pivotable base 12 and the second pivotable base 13 are positioned in between the first attachment mechanism 5 and the second attachment mechanism 9 so that the attaching a camera to the camera mount 2 does not impede the movement of the rotatable attachment formed between the links of the chain of camera mounts.

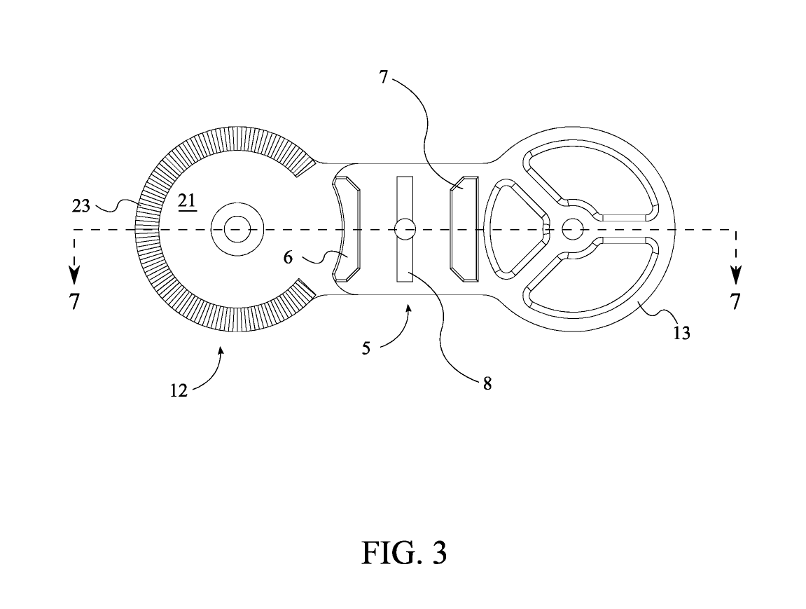

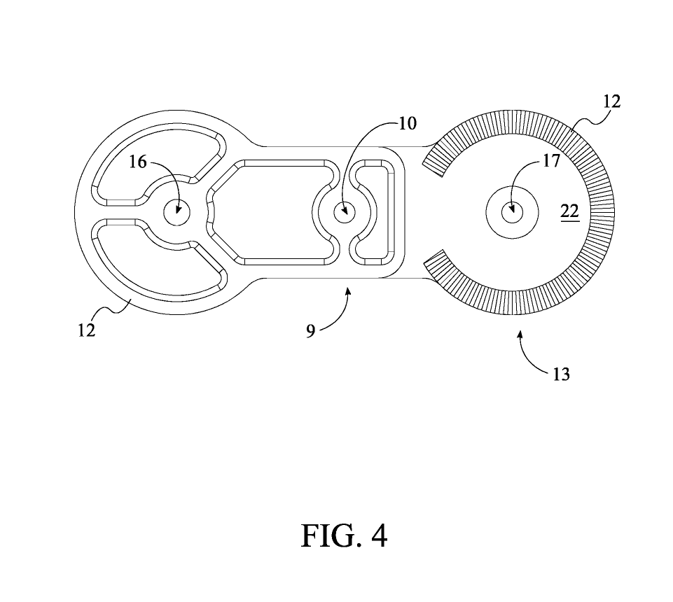

Regarding FIG. 3, FIG. 4, and FIG. 7, as described above, the first attachment mechanism 5 is designed to interface with a camera mounting system that differs from a camera mounting system which is compatible with the second attachment mechanism 9. As such, the first attachment mechanism 5 comprises a first camera-clamping bracket 6, a second camera-clamping bracket 7, and a camera rail 8. The term “camera mounting system” is used herein to describe an intermediary connector that is used to attach a camera to an external mounting device. The first camera-clamping bracket 6 and the second camera-clamping bracket 7 are rigid clamps that work in concert to clamp around the camera mounting system of a camera. To accomplish this, the first camera-clamping bracket 6 and the second camera-clamping bracket 7 are positioned offset from each other across the mount body 4. Accordingly, the first camera-clamping bracket 6 and the second camera-clamping bracket 7 are able to retain an attached camera in a desired orientation while clamped around the camera mounting system of the attached camera. The camera rail 8 is a rigid rail that is designed to interface with the camera mounting system of an attached camera. The cameral rail is positioned in between the first camera-clamping bracket 6 and the second camera-clamping bracket 7. Additionally, the first camera-clamping bracket 6, the second camera-clamping bracket 7, and the camera rail 8 being positioned parallel with each other. Consequently, the camera rail 8 maintains the camera mounting system of an attached camera in an orientation which enables the first camera-clamping bracket 6 and the second camera-clamping bracket 7 to form a clamping connection. The second attachment mechanism 9 is designed to function as an attachment point for a camera mounting system that is substantially different than the camera mounting systems which can interface with the first attachment mechanism 5. As such, the second attachment mechanism 9 comprises a female threading 11 and a peg-receiving receptacle 10. The peg-receiving receptacle 10 traverses into the mount body 4. Furthermore, the female threading 11 is laterally connected within the peg-receiving receptacle 10 so that the universal threaded connector of a camera mounting system can be attached to the camera mount.

Although the invention has been explained in relation to its preferred embodiment, it is to be understood that many other possible modifications and variations can be made without departing from the spirit and scope of the invention as hereinafter claimed.

What is claimed is:

1. An interlocking camera mount used to form an adjustable chain comprises:
a plurality of interlocking links;
each of the plurality of interlocking links comprises a camera mount, a first pivotable base, and a second pivotable base;
the first pivotable base being connected adjacent to the camera mount;
the second pivotable base being connected adjacent to the camera mount, opposite to the first pivotable base;
the first pivotable base and the second pivotable base being positioned offset from each other along the camera mount; and
the first pivotable base of an arbitrary link being rotatably attached to the second pivotable base of an adjacent link, wherein the arbitrary link and the adjacent link are from the plurality of interlocking links.

2. The interlocking camera mount used to form an adjustable chain as claimed in claim 1 comprises:
each of the plurality of interlocking links further comprises a first fastening hole and a second fastening hole;
the first fastening hole traversing through the first pivotable base;
the first fastening hole being centrally positioned on the first pivotable base; and
the second fastening hole traversing through the second pivotable base;
the second fastening hole being centrally positioned on the second pivotable base.

3. The interlocking camera mount used to form an adjustable chain as claimed in claim 2 comprises:
a fastener;
the first fastening hole of the arbitrary link and the second fastening hole of the adjacent link being concentrically aligned to each other; and
the fastener being engaged through the first fastening hole of the arbitrary link and the second fastening hole of the adjacent link.

4. The interlocking camera mount used to form an adjustable chain as claimed in claim 1 comprises:
each of the plurality of interlocking links further comprises a cylindrical protrusion and a cylindrical receptacle;
an inner face of the first pivotable base and an inner face of the second pivotable base being oriented towards each other;
the inner face of the first pivotable base and the inner face of the second pivotable base being positioned parallel each other;
the cylindrical receptacle centrally traversing into the first pivotable base from the inner surface of the first pivotable base; and
the cylindrical protrusion being centrally connected onto the inner surface of the second pivotable base.

5. The interlocking camera mount used to form an adjustable chain as claimed in claim 4 comprises:
the cylindrical protrusion of the adjacent link and the cylindrical receptacle of the arbitrary link being concentrically aligned to each other; and
the cylindrical protrusion of the adjacent link and the cylindrical receptacle of the arbitrary link being engaged to each other.

6. The interlocking camera mount used to form an adjustable chain as claimed in claim 1 comprises:
each of the plurality of interlocking links further comprises a first crown gear and a second crown gear;
an inner face of the first pivotable base and an inner face of the second pivotable base being oriented towards each other;
the inner face of the first pivotable base and the inner face of the second pivotable base being positioned parallel each other;
the first crown gear being integrated into the inner surface of the first pivotable base; and
the second crown gear being integrated into the inner surface of the second pivotable base.

7. The interlocking camera mount used to form an adjustable chain as claimed in claim 6 comprises:
the first crown gear of the arbitrary link and the second crown gear of the adjacent link being concentrically aligned to each other; and
the first crown gear of the arbitrary link and the second crown gear of the adjacent link being engaged to each other.

8. The interlocking camera mount used to form an adjustable chain as claimed in claim 1 comprises:
the first pivotable base and the second pivotable base being positioned equidistant from a central axis of the camera mount; and
the first pivotable base being positioned offset from the second pivotable base along a central axis of the camera mount.

9. The interlocking camera mount used to form an adjustable chain as claimed in claim 1 comprises:
the camera mount comprises a first attachment mechanism, a second attachment mechanism, and a mount body;
the first attachment mechanism being connected adjacent to the mount body;
the second attachment mechanism being connected adjacent to the mount body, opposite to the first attachment mechanism; and
the first pivotable base and the second pivotable base being positioned in between the first attachment mechanism and the second attachment mechanism.

10. The interlocking camera mount used to form an adjustable chain as claimed in claim 9 comprises:
the first attachment mechanism comprises a first camera-clamping bracket, a second camera-clamping bracket, and a camera rail;
the first camera-clamping bracket and the second camera-clamping bracket being positioned offset from each other across the camera mount;
the cameral rail being positioned in between the first camera-clamping bracket and the second camera-clamping bracket; and
the first camera-clamping bracket, the second camera-clamping bracket, and the camera rail being positioned parallel with each other.

11. The interlocking camera mount used to form an adjustable chain as claimed in claim 9 comprises:
the second attachment mechanism comprises a female threading and a peg-receiving receptacle;
the peg-receiving receptacle traversing into the mount body; and
the female threading being laterally connected within the peg-receiving receptacle.

12. An interlocking camera mount used to form an adjustable chain comprises:
a plurality of interlocking links;
each of the plurality of interlocking links comprises a camera mount, a first pivotable base, and a second pivotable base;
the first pivotable base being connected adjacent to the camera mount;
the second pivotable base being connected adjacent to the camera mount, opposite to the first pivotable base;
the first pivotable base and the second pivotable base being positioned offset from each other along the camera mount;
the first pivotable base of an arbitrary link being rotatably attached to the second pivotable base of an adjacent link, wherein the arbitrary link and the adjacent link are from the plurality of interlocking links;
the first pivotable base and the second pivotable base being positioned equidistant from a central axis of the camera mount; and
the first pivotable base being positioned offset from the second pivotable base along a central axis of the camera mount.

13. The interlocking camera mount used to form an adjustable chain as claimed in claim 12 comprises:
a fastener;
each of the plurality of interlocking links further comprises a first fastening hole and a second fastening hole;
the first fastening hole traversing through the first pivotable base;
the first fastening hole being centrally positioned on the first pivotable base;
the second fastening hole traversing through the second pivotable base;
the second fastening hole being centrally positioned on the second pivotable base;
the first fastening hole of the arbitrary link and the second fastening hole of the adjacent link being concentrically aligned to each other; and
the fastener being engaged through the first fastening hole of the arbitrary link and the second fastening hole of the adjacent link.

14. The interlocking camera mount used to form an adjustable chain as claimed in claim 12 comprises:
each of the plurality of interlocking links further comprises a cylindrical protrusion and a cylindrical receptacle;
an inner face of the first pivotable base and an inner face of the second pivotable base being oriented towards each other;
the inner face of the first pivotable base and the inner face of the second pivotable base being positioned parallel each other;
the cylindrical receptacle centrally traversing into the first pivotable base from the inner surface of the first pivotable base;
the cylindrical protrusion being centrally connected onto the inner surface of the second pivotable base;
the cylindrical protrusion of the adjacent link and the cylindrical receptacle of the arbitrary link being concentrically aligned to each other; and
the cylindrical protrusion of the adjacent link and the cylindrical receptacle of the arbitrary link being engaged to each other.

15. The interlocking camera mount used to form an adjustable chain as claimed in claim 12 comprises:
each of the plurality of interlocking links further comprises a first crown gear and a second crown gear;
an inner face of the first pivotable base and an inner face of the second pivotable base being oriented towards each other;
the inner face of the first pivotable base and the inner face of the second pivotable base being positioned parallel each other;
the first crown gear being integrated into the inner surface of the first pivotable base;
the second crown gear being integrated into the inner surface of the second pivotable base;
the first crown gear of the arbitrary link and the second crown gear of the adjacent link being concentrically aligned to each other; and
the first crown gear of the arbitrary link and the second crown gear of the adjacent link being engaged to each other.

16. The interlocking camera mount used to form an adjustable chain as claimed in claim 12 comprises:
the camera mount comprises a first attachment mechanism, a second attachment mechanism, and a mount body;
the first attachment mechanism comprises a first camera-clamping bracket, a second camera-clamping bracket, and a camera rail;
the second attachment mechanism comprises a female threading and a peg-receiving receptacle;
the first attachment mechanism being connected adjacent to the mount body;
the second attachment mechanism being connected adjacent to the mount body, opposite to the first attachment mechanism;
the first pivotable base and the second pivotable base being positioned in between the first attachment mechanism and the second attachment mechanism;
the first camera-clamping bracket and the second camera-clamping bracket being positioned offset from each other across the camera mount;
the cameral rail being positioned in between the first camera-clamping bracket and the second camera-clamping bracket;
the first camera-clamping bracket, the second camera-clamping bracket, and the camera rail being positioned parallel with each other;
the peg-receiving receptacle traversing into the mount body; and
the female threading being laterally connected within the peg-receiving receptacle.

17. An interlocking camera mount used to form an adjustable chain comprises:
a plurality of interlocking links;
a fastener;
each of the plurality of interlocking links comprises a camera mount, a first pivotable base, a second pivotable base, a first fastening hole, a second fastening hole, a cylindrical protrusion, a cylindrical receptacle, a first crown gear, and a second crown gear;
the camera mount comprises a first attachment mechanism, a second attachment mechanism, and a mount body;
the first pivotable base being connected adjacent to the camera mount;
the second pivotable base being connected adjacent to the camera mount, opposite to the first pivotable base;
the first pivotable base and the second pivotable base being positioned offset from each other along the camera mount;
the first pivotable base of an arbitrary link being rotatably attached to the second pivotable base of an adjacent link, wherein the arbitrary link and the adjacent link are from the plurality of interlocking links;
the first fastening hole traversing through the first pivotable base;
the first fastening hole being centrally positioned on the first pivotable base;
the second fastening hole traversing through the second pivotable base;
the second fastening hole being centrally positioned on the second pivotable base;
the first fastening hole of the arbitrary link and the second fastening hole of the adjacent link being concentrically aligned to each other;
the fastener being engaged through the first fastening hole of the arbitrary link and the second fastening hole of the adjacent link;
an inner face of the first pivotable base and an inner face of the second pivotable base being oriented towards each other;
the inner face of the first pivotable base and the inner face of the second pivotable base being positioned parallel each other;
the cylindrical receptacle centrally traversing into the first pivotable base from the inner surface of the first pivotable base;
the cylindrical protrusion being centrally connected onto the inner surface of the second pivotable base;
the first pivotable base and the second pivotable base being positioned equidistant from a central axis of the camera mount;
the first pivotable base being positioned offset from the second pivotable base along a central axis of the camera mount;
the first crown gear being integrated into the inner surface of the first pivotable base;
the second crown gear being integrated into the inner surface of the second pivotable base;
the first attachment mechanism being connected adjacent to the mount body;
the second attachment mechanism being connected adjacent to the mount body, opposite to the first attachment mechanism; and
the first pivotable base and the second pivotable base being positioned in between the first attachment mechanism and the second attachment mechanism.

18. The interlocking camera mount used to form an adjustable chain as claimed in claim 17 comprises:
the cylindrical protrusion of the adjacent link and the cylindrical receptacle of the arbitrary link being concentrically aligned to each other; and
the cylindrical protrusion of the adjacent link and the cylindrical receptacle of the arbitrary link being engaged to each other.

19. The interlocking camera mount used to form an adjustable chain as claimed in claim 17 comprises:
the first crown gear of the arbitrary link and the second crown gear of the adjacent link being concentrically aligned to each other; and
the first crown gear of the arbitrary link and the second crown gear of the adjacent link being engaged to each other.

20. The interlocking camera mount used to form an adjustable chain as claimed in claim 17 comprises:
the first attachment mechanism comprises a first camera-clamping bracket, a second camera-clamping bracket, and a camera rail;
the second attachment mechanism comprises a female threading and a peg-receiving receptacle;
the first camera-clamping bracket and the second camera-clamping bracket being positioned offset from each other across the camera mount;
the cameral rail being positioned in between the first camera-clamping bracket and the second camera-clamping bracket;
the first camera-clamping bracket, the second camera-clamping bracket, and the camera rail being positioned parallel with each other;
the peg-receiving receptacle traversing into the mount body; and
the female threading being laterally connected within the peg-receiving receptacle
